(19) United States
(12) Patent Application Publication
(10) Pub. No.: US 2006/0095651 A1
(43) Pub. Date: May 4, 2006

(54) Firmware rewrite system for disk apparatus

(75) Inventor: Hirofumi Tani, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 11/266,490

(22) Filed: Nov. 4, 2005

(30) Foreign Application Priority Data
Nov. 4, 2004 (JP) P2004-320925

(51) Int. Cl. G06F 12/00

(52) U.S. Cl. 711/103; 711/112; 711/165

(57) ABSTRACT

From an optical disk holding plural pieces of firmware corresponding to the hardware specifications of plural disk apparatuses and plural rewrite programs for rewriting the respective pieces of firmware, firmware which corresponds to the hardware specification of a disk apparatus and an associated rewrite program are selected and read, thus read firmware and the associated rewrite program are transferred to a RAM, the rewrite program transferred to the RAM is executed, and the firmware transferred to the RAM is written in a flash ROM.

### BACKGROUND OF THE INVENTION

1. Field of the Invention

The present invention relates to a disk apparatus which records information data on an optical disk and plays back information data from an optical disk, and more particularly, to a firmware rewrite system for a disk apparatus for rewriting firmware which controls a system of a disk apparatus.

2. Description of the Related Art

A conventional approach for rewriting firmware which controls a system of a disk apparatus written in a flash ROM (ReadOnlyMemory) of the disk apparatus is to transfer a firmware rewrite program stored in a ROM of the disk apparatus to a RAM (RandomAccessMemory) of the disk apparatus, execute the rewrite program transferred to the RAM of the disk apparatus, write the firmware in the flash ROM of the disk apparatus and accordingly rewrite the firmware for the disk apparatus, and thus requires storage of the firmware rewrite program in the ROM of the disk apparatus, and therefore, has a problem that it is not possible to reduce the capacity of the ROM of the disk apparatus. There is a further problem that since specifications of hardware such as a microcomputer, interface, an internal bus and external input/output terminals are different between different models of disk apparatuses, it is necessary to individually manage different pieces of firmware and write programs corresponding to the different hardware specifications for the different models of disk apparatuses and that for rewriting of the firmware of the disk apparatus, an operator must select the firmware and the rewrite program corresponding to the hardware specification for the disk apparatus from among the pieces of the firmware individually managed for the different models of disk apparatuses and must rewrite the firmware for the disk apparatus.

According to one conventional technique, a system control program (firmware) which controls a system of an electronic apparatus and a write control program (write program) for writing the system control program are stored in a RAM via JTAG (Joint Test Action Group) interface, the write control program stored in the RAM is executed, and the system control program stored in the RAM is written in a flash memory which stores the system control program which controls the system of the electronic apparatus (See JP-A-2002-278783.).

According to another, a CD-R (Compact Disk-Recordable) disk is played back in which a rewrite program has been recorded together with firmware update data for a flash ROM, the rewrite program is transferred to an internal RAM of a system controlling microcomputer, the update data are read from the CD-R disk and transferred to a decode memory which decodes the data, the rewrite program stored in the internal RAM of the microcomputer is executed, and the firmware in the flash ROM is updated (See JP-A-2002-149427 for instance.).

### SUMMARY OF THE INVENTION

However, the former conventional technique, although permitting storage of the system control program which controls the system of the electronic apparatus and the write control program for writing the system control program in the RAM via the JTAG interface and execution of the write control program stored in the RAM to thereby write the system control program stored in the RAM in the flash memory which stores the system control program which controls the system of the electronic apparatus, requires connection of a host computer to the electronic apparatus to write the system control program which controls the system of the electronic apparatus, and therefore, does not solve the problems above.

Meanwhile, the latter conventional technique, according to which the CD-R disk is played back in which the rewrite program has been recorded together with the firmware update data for the flash ROM, the rewrite program is transferred to the internal RAM of the system controlling microcomputer, the update data are read from the CD-R disk and transferred to the decode memory which decodes the data, the rewrite program stored in the internal RAM of the microcomputer is executed and the firmware in the flash ROM is updated, aims at rewriting the firmware for the system controlling microcomputer of a disk apparatus by playing back the CD-R disk without storing a rewrite program in the flash ROM, and as such, does not provide a solution to the problems above.

The present invention has been made in light of these problems with the conventional techniques, and accordingly, an object of the present invention is to provide a firmware rewrite system for a disk apparatus with which it is possible to rewrite firmware for a disk apparatus by selecting firmware corresponding to the hardware specification of the disk apparatus and a rewrite program for rewriting the firmware.

To achieve the object above, according to an aspect of the present invention, a firmware rewrite system for a disk apparatus for rewriting firmware which has been written in a flash ROM and controls a system of a disk apparatus includes: a reading unit which selects and reads firmware corresponding to the hardware specification of a disk apparatus and an associated rewrite program from an optical disk in which plural pieces of firmware corresponding to the hardware specifications of plural disk apparatuses and plural rewrite programs for rewriting the respective pieces of firmware have been recorded; a transfer unit which transfers the firmware and the associated rewrite program read by the reading unit to a RAM; and a writing unit which executes the rewrite program transferred to the RAM, writes the firmware transferred to the RAM in the flash ROM, and writes the rewrite program transferred to the RAM in the flash ROM.

When a rewrite program has been written in the flash ROM, the transfer unit may transfer this rewrite program written in the flash ROM to the RAM.

When there is a free capacity in the flash ROM to write a rewrite program, the writing unit writes the rewrite program transferred to the RAM in the flash ROM.

Using these means, it is possible to select firmware corresponding to the hardware specification of a disk apparatus and a rewrite program for rewriting this firmware, and to rewrite the firmware for the disk apparatus.

With the firmware rewrite system for a disk apparatus according to the above-aspect of the invention, firmware which corresponds to the hardware specification of a disk apparatus is selected and read from an optical disk in which plural pieces of firmware corresponding to the hardware specifications of plural disk apparatuses and plural rewrite programs for rewriting the respective pieces of firmware have been recorded, and when a rewrite program has not been written in the flash ROM, a firmware rewrite program which corresponds to the hardware specification of the disk apparatus is selected and read from the optical disk and thus read firmware is transferred to the RAM, and when a rewrite program has not been written in the flash ROM, the rewrite program read from the optical disk is transferred to the RAM, but when a rewrite program has been written in the flash ROM, the rewrite program written in the flash ROM is transferred to the RAM, the rewrite program transferred to the RAM is executed and the firmware transferred to the RAM is written in the flash ROM, and therefore, it is possible to select the firmware which corresponds to the hardware specification of the disk apparatus and the associated rewrite program and to rewrite the firmware for the disk apparatus. Further, when there is a free capacity in the flash ROM to write a rewrite program, the rewrite program transferred to the RAM is written in the flash ROM, and hence, upon a read error due to a scratch, contamination or the like of the optical disk which necessitates retried reading, it is possible to shorten a period of time needed for transfer of the rewrite program than where the rewrite program must be read from the optical disk and then transferred to the RAM.

With the firmware rewrite system for a disk apparatus according to the above-aspect of the invention, firmware which corresponds to the hardware specification of a disk apparatus and an associated rewrite program are selected and read from an optical disk in which plural pieces of firmware corresponding to the hardware specifications of plural disk apparatuses and plural rewrite programs for rewriting the respective pieces of firmware have been recorded, the firmware and the associated rewrite program read from the optical disk are transferred to the RAM, the rewrite program transferred to the RAM is executed, the firmware transferred to the RAM is written in the flash ROM and the rewrite program transferred to the RAM is written in the flash ROM, and therefore, it is possible to select the firmware which corresponds to the hardware specification of the disk apparatus and the associated rewrite program and to rewrite the firmware for the disk apparatus.

With the firmware rewrite system for a disk apparatus according to according to the above-aspect of the invention, when a rewrite program has been written in the flash ROM, the rewrite program written in the flash ROM is transferred to the RAM, and therefore, upon a read error due to a scratch, contamination or the like of the optical disk which necessitates retried reading, it is possible to shorten a period of time needed for transfer of the rewrite program than where the rewrite program must be read from the optical disk and then transferred to the RAM.

With the firmware rewrite system for a disk apparatus according to the above-aspect of the invention, when there is a free capacity in the flash ROM to write a rewrite program, the rewrite program transferred to the RAM is written in the flash ROM, and therefore, when there is a free capacity in the flash ROM to write a rewrite program, it is possible to make effective use of the free capacity in the flash ROM.

### BRIEF DESCRIPTION OF THE DRAWINGS

FIG. 1 is a block diagram which shows the structure of the firmware rewrite system for a disk apparatus according to the embodiment of the present invention.

FIGS. 2A-2C are explanatory diagrams which show the operations which the firmware rewrite system for a disk apparatus according to the embodiment of the present invention performs.

FIG. 3 is a flowchart which shows the operations which the firmware rewrite system for a disk apparatus according to the embodiment of the present invention performs.

FIG. 4 is a flowchart which shows the operations which the firmware rewrite system for a disk apparatus according to the embodiment of the present invention performs.

### DESCRIPTION OF THE PREFERRED EMBODIMENTS

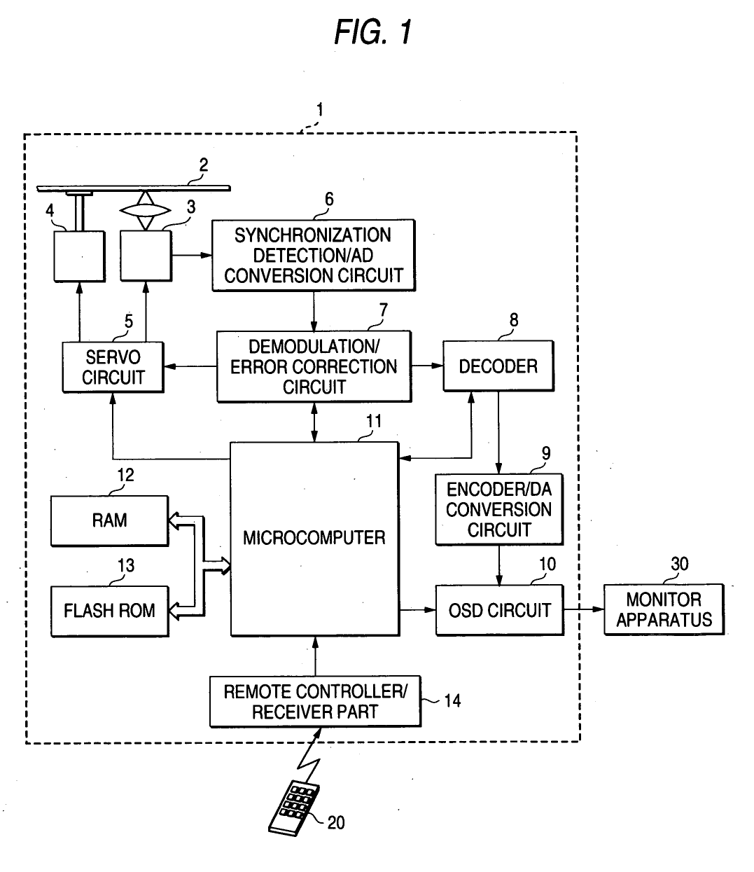

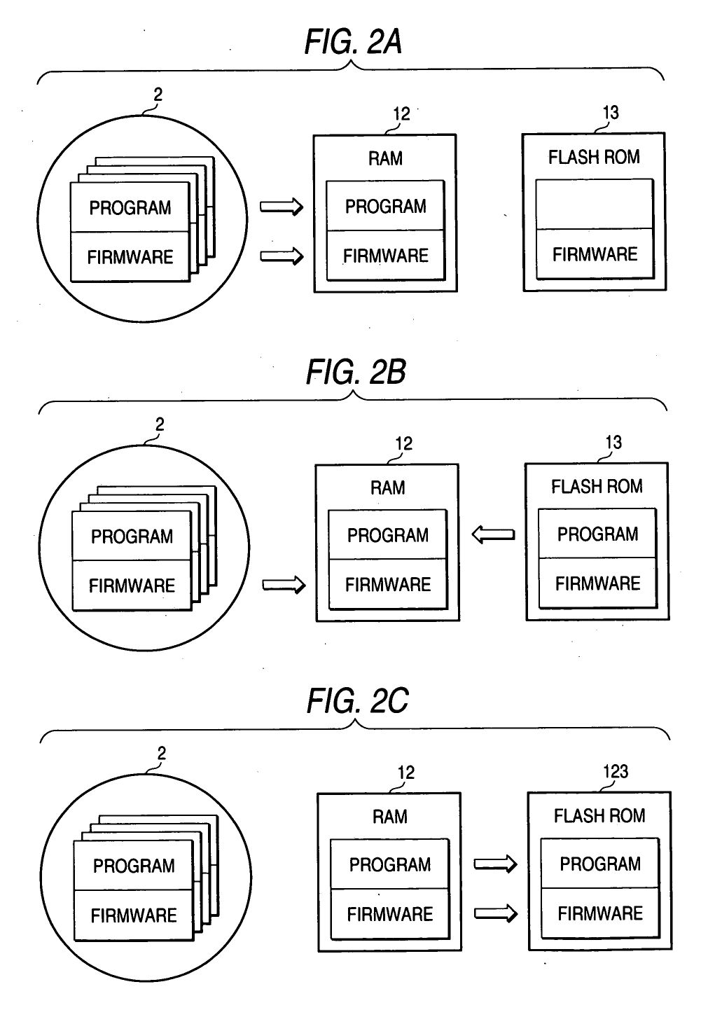

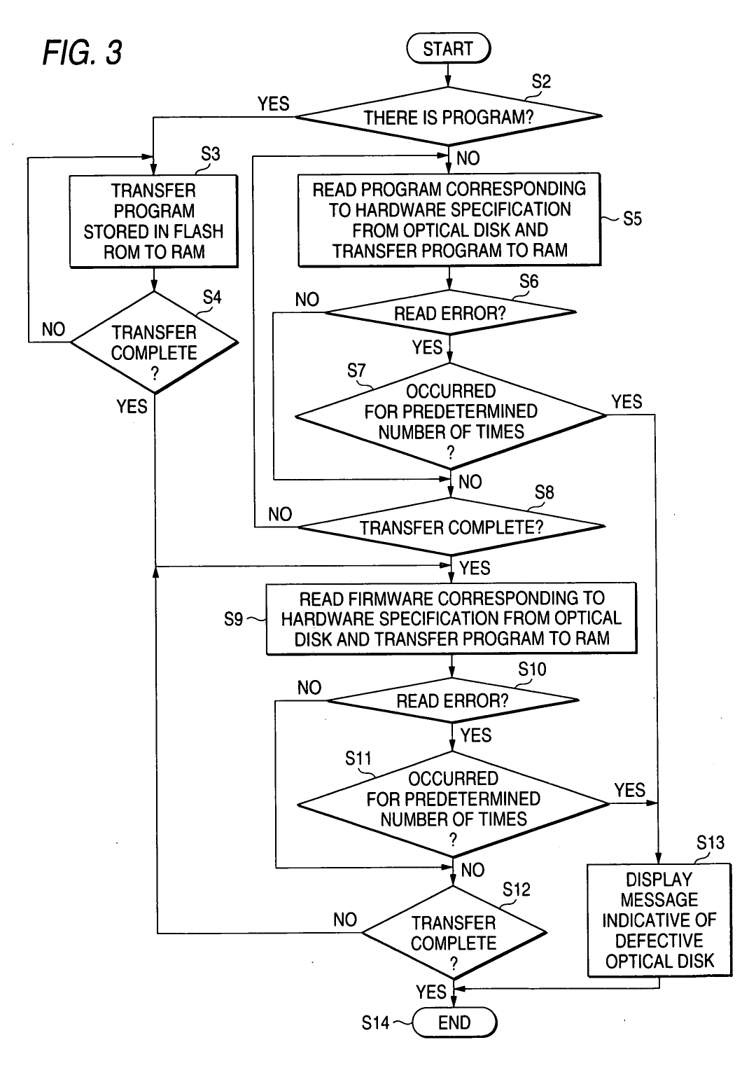

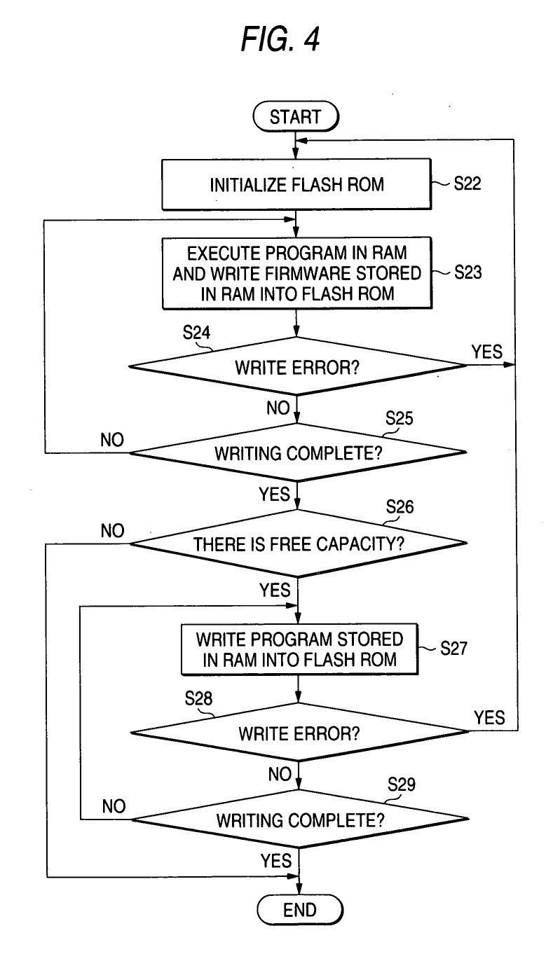

A best mode to implement the present invention will now be described with reference to the associated drawings. FIG. 1 is a block diagram which shows a structure of a firmware rewrite system for a disk apparatus according to an embodiment of the present invention, FIG. 2 is an explanatory diagram which shows operations which the firmware rewrite system for a disk apparatus according to the embodiment of the present invention performs, FIG. 3 is a flowchart which shows operations which the firmware rewrite system for a disk apparatus according to the embodiment of the present invention performs, and FIG. 4 is a flowchart which shows operations which the firmware rewrite system for a disk apparatus according to the embodiment of the present invention performs.

First, the block diagram in FIG. 1 which shows the structure of the firmware rewrite system for a disk apparatus according to the embodiment of the present invention will be referred to.

A disk apparatus 1 includes an optical pick-up 3 which optically reads information data recorded on an optical disk 2, a spindle motor 4 which rotates the optical disk 2, a servo circuit 5 which drives the spindle motor 4 and a thread motor (not shown), which moves the optical pick-up 3 along the direction of the radius of the optical disk 2, and servo-controls the focus and tracking of the optical pick-up 3, a synchronization detection/AD conversion circuit 6 which detects synchronization of information data read by the optical pick-up 3 based on a reference clock and converts information data in the form of an analog signal into information data in the form of a digital signal, a demodulation/error correction circuit 7 which demodulates information data converted into a digital signal and corrects an error in the thus demodulated information data, a decoder 8 which expands information data which have been compressed in accordance with a predetermined compression method and decodes original information data, an encoder/DA conversion circuit 9 which encodes a video/audio signal of the thus decoded information data into a video/audio signal which is a composite signal complying with a predetermined signal scheme, e.g., an NTSC (National Television System Committee) video/audio signal and converts the thus encoded video/audio signal into a video/audio signal which is an analog signal, an OSD (On-Screen Character Display) circuit 10 which superimposes a character information signal upon a video signal and displays character information on a screen of a monitor apparatus 30, a microcomputer 11 which controls the entire system of the disk apparatus 1, a RAM 12 which temporarily stores firmware which controls the system of the disk apparatus 1 and a rewrite program for rewriting the firmware for the disk apparatus 1, a flash ROM 13 which stores the firmware which controls the system of the disk apparatus 1, and a remote controller/receiver part 14 which receives an infrared remote control signal sent from a remote controlling device 20 and converts the same into a predetermined electric signal.

Operations performed by the firmware rewrite system for a disk apparatus having the above structure will now be described.

As the optical disk 2 holding plural pieces of firmware corresponding to the hardware specifications of plural disk apparatuses and plural rewrite programs for rewriting the respective pieces of firmware is set in the disk apparatus 1 and rewriting of firmware for the disk apparatus 1 is demanded by an operation entered via an operation key (not shown) of the remote controlling device 20, the microcomputer 11 determines whether a rewrite program has been written in the flash ROM 13, and when finding a rewrite program written in the flash ROM 13, transfers the rewrite program written in the flash ROM 13 to the RAM 12 (FIG. 2B).

When not finding any rewrite program written in the flash ROM 13, the microcomputer 11 sends a control signal to the servo circuit 5 so that the optical pick-up 3 selects and reads the rewrite program corresponding to the hardware specification of the disk apparatus 1 from the optical disk 2 in which the plural pieces of firmware corresponding to the hardware specifications of the plural disk apparatuses and the plural rewrite programs for rewriting the respective pieces of firmware have been recorded and this rewrite program is transferred to the RAM 12 (FIG. 2A). Upon occurrence of an error in reading the rewrite program, the microcomputer 11 retries reading the rewrite program, and after read errors having occurred for a predetermined number of times, e.g., five times, the microcomputer 11 sends a character information signal and a control signal to the OSD circuit 10, displays a message notifying that the optical disk 2 is defective (not shown) on the screen of the monitor apparatus 30, and stops rewriting the firmware for the disk apparatus 1.

As transfer of the rewrite program read from the optical disk 2 to the RAM 12 is completed, the microcomputer 11 sends a control signal to the servo circuit 5 so that the optical pick-up 3 selects and reads the firmware which corresponds to the hardware specification of the disk apparatus 1 from the optical disk 2 in which the plural pieces of firmware corresponding to the hardware specifications of the plural disk apparatuses and the plural rewrite programs for rewriting the respective pieces of firmware have been recorded and this firmware is transferred to the RAM 12 (FIGS. 2A and 2B). Upon occurrence of an error in reading the firmware, the microcomputer 11 retries reading the firmware, and after read errors having occurred for a predetermined number of times, e.g., five times, the microcomputer 11 sends a character information signal and a control signal to the OSD circuit 10, displays a message notifying that the optical disk 2 is defective (not shown) appear on the screen of the monitor apparatus 30, and stops rewriting the firmware for the disk apparatus 1.

As transfer of the firmware read from the optical disk 2 to the RAM 12 is completed, the microcomputer 11 sends a control signal to the flash ROM 13, initializes the flash ROM 13 and deletes data such as firmware which have been rewritten in the flash ROM 13. The microcomputer 11 then executes the rewrite program transferred to the RAM 12, and writes the firmware transferred to the RAM 12 in the flash ROM 13 (FIG. 2C). Upon occurrence of an error in writing the firmware transferred to the RAM 12 in the flash ROM 13, the microcomputer 11 sends a control signal to the flash ROM 13, initializes the flash ROM 13 and retries writing of the firmware in the flash ROM 13 from initializing.

As writing of the firmware transferred to the RAM 12 in the flash ROM 13 is completed, the microcomputer 11 determines whether there is a free capacity in the flash ROM 13 to write a rewrite program, and when finding a free capacity in the flash ROM 13 to write a rewrite program, writes the rewrite program transferred to the RAM 12 in the flash ROM 13 and completes rewriting of the firmware (FIG. 2C).

Upon occurrence of an error in writing the rewrite program transferred to the RAM 12 in the flash ROM 13, the microcomputer 11 sends a control signal to the flash ROM 13, initializes the flash ROM 13 and retries writing the firmware in the flash ROM 13.

The flowchart in FIG. 3 which shows operations which the firmware rewrite system for a disk apparatus according to the embodiment of the present invention performs will now be referred to.

As the optical disk holding the plural pieces of firmware corresponding to the hardware specifications of the plural disk apparatuses and the plural rewrite programs for rewriting the respective pieces of firmware is set in the disk apparatus and rewriting of the firmware for the disk apparatus is demanded, the sequence proceeds from Step S1 to Step S2 at which whether are write program has been written in the flash ROM is determined, and the sequence then proceeds to Step S3 when it is found that a rewrite program has been written in the flash ROM, whereas when it is found that a rewrite program has not been written in the flash ROM, the sequence proceeds to Step S5.

At Step S3, the rewrite program which has been written in the flash ROM is transferred to the RAM, and the sequence proceeds to Step S4.

At Step S4, whether transfer of the rewrite program written in the flash ROM to the RAM has been completed is determined, and the sequence proceeds to Step S9 when the transfer of the rewrite program to the RAM has been completed but returns back to Step S3 and repeats the steps starting with Step S3 when the transfer of the rewrite program to the RAM has not been completed.

At Step S5, the firmware which corresponds to the hardware specification of the disk apparatus is selected and read from the optical disk and then transferred to the RAM of the disk apparatus, and the sequence proceeds to Step S6.

At Step S6, whether an error has occurred during reading of the rewrite program is determined, and the sequence then proceeds to Step S7 when it is found that an error has occurred during reading of the rewrite program but to Step S8 when it is found that any error has not occurred during reading of the rewrite program.

At Step S7, whether errors have occurred for a predetermined number of times during reading of the rewrite program is determined, and the sequence then proceeds to Step S13 when it is found that errors have occurred for the predetermined number of times during reading of the rewrite program but to Step S8 when it is found that errors have not occurred for the predetermined number of times during reading of the rewrite program.

At Step S8, whether transfer of the rewrite program to the RAM has been completed is determined, and the sequence proceeds to Step S9 when the transfer of the rewrite program to the RAM has been completed but returns back to Step S5 and repeats the steps starting with Step S5 when the transfer of the rewrite program to the RAM has not been completed.

At Step S9, the firmware which corresponds to the hardware specification of the disk apparatus is selected and read from the optical disk and then transferred to the RAM, and the sequence proceeds to Step S10.

At Step S10, whether an error has occurred during reading of the firmware is determined, and the sequence then proceeds to Step S11 when it is found that an error has occurred during reading of the firmware but to Step S12 when it is found that any error has not occurred during reading of the firmware.

At Step S11, whether errors have occurred for a predetermined number of times during reading of the firmware is determined, and the sequence then proceeds to Step S13 when it is found that errors have occurred for the predetermined number of times during reading of the firmware but to Step S12 when it is found that errors have not occurred for the predetermined number of times during reading of the firmware.

At Step S12, whether transfer of the firmware to the RAM has been completed is determined, and the sequence proceeds to Step S14 and the processing is terminated when the transfer of the firmware to the RAM has been completed but returns back to Step S9 and repeats the steps starting with Step S9 when the transfer of the firmware to the RAM has not been completed.

At Step S13, a message telling that the optical disk is defective appears on the screen of the monitor apparatus, rewriting of the firmware is stopped, and the sequence proceeds to Step S14 at which the processing is terminated.

The flowchart in FIG. 4 which shows operations which the firmware rewrite system for a disk apparatus according to the embodiment of the present invention performs will now be referred to.

Upon transfer of the rewrite program and the firmware to the RAM, the sequence proceeds from Step S21 to Step S22 at which the flash ROM is initialized and data such as firmware which have been rewritten in the flash ROM are deleted, and the sequence proceeds to Step S23.

At Step S23, the firmware rewrite program transferred to the RAM is executed, the firmware transferred to the RAM is written in the flash ROM, and the sequence proceeds to Step S24.

At Step S24, whether an error has occurred during writing of the firmware in the flash ROM is determined, and the sequence returns back to Step S22 and repeats the steps starting with Step S22 when it is found that an error has occurred during writing of the firmware in the flash ROM but the sequence proceeds to Step S25 when it is found that any error has not occurred during writing of the firmware in the flash ROM. At Step S25, whether writing of the firmware in the flash ROM has been completed is determined, and the sequence then proceeds to Step S26 when writing of the firmware in the flash ROM has been completed but the sequence returns back to Step S23 and repeats the steps starting with Step S23 when writing of the firmware in the flash ROM has not been completed.

At Step S26, whether there is a free capacity in the flash ROM to write a rewrite program is determined, and the sequence proceeds to Step S27 when there is a free capacity in the flash ROM to write a rewrite program but the sequence proceeds to Step S30 and the processing is terminated when there is not a free capacity in the flash ROM to write a rewrite program.

At Step S27, the rewrite program transferred to the RAM is written in the flash ROM of the disk apparatus, and the sequence proceeds to Step S28.

At Step S28, whether an error has occurred during writing of the rewrite program in the flash ROM is determined, and the sequence returns back to Step S22 and repeats the steps starting with Step S22 when it is found that an error has occurred during writing of the rewrite program in the flash ROM but the sequence proceeds to Step S29 when it is found that any error has not occurred during writing of the rewrite program in the flash ROM.

At Step S29, whether writing of the rewrite program in the flash ROM has been completed is determined, and the sequence proceeds to Step S30 and the processing is terminated when writing of the rewrite program in the flash ROM has been completed but the sequence returns back to Step S27 and repeats the steps starting with Step S27 when writing of the rewrite program in the flash ROM has not been completed.

Although the foregoing has described the best mode to carry out the present invention in detail, the present invention is not limited to this but may be modified or improved to the extent those skilled in the art may do so. For example, although the foregoing has been described in the event that a rewrite program has been written in a flash ROM, the rewrite program written in the flash ROM is transferred to a RAM, a firmware rewrite program which corresponds to the hardware specification of a disk apparatus may be selected and read from an optical disk even when a rewrite program has been written in a flash ROM.

What is claimed is:

1. A firmware rewrite system for a disk apparatus, which rewrites firmware written in a flash ROM and controls a system of the disk apparatus, comprising:
a reading unit which selects and reads firmware corresponding to a hardware specification of the disk apparatus from an optical disk in which plural pieces of firmware corresponding to the hardware specifications of plural disk apparatuses and plural rewrite programs for rewriting the respective pieces of firmware have been recorded, and selects and reads a rewrite program corresponding to the hardware specification of the disk apparatus from the optical disk when any rewrite program has not been written in the flash ROM;
a transfer unit which transfers the firmware read by the reading unit to a RAM, transfers the rewrite program read by the reading unit to the RAM when any rewrite program has not been written in the flash ROM, but when a rewrite program has been written in the flash ROM, transfers the rewrite program written in the flash ROM to the RAM; and
a writing unit which executes the rewrite program transferred to the RAM, writes the firmware transferred to the RAM in the flash ROM, and when there is a free capacity in the flash ROM to write a rewrite program, writes the rewrite program transferred to the RAM in the flash ROM.

2. A firmware rewrite system for a disk apparatus, which rewriting firmware written in a flash ROM and controls a system of a disk apparatus, comprising:
a reading unit which selects and reads firmware corresponding to the hardware specification of a disk apparatus and an associated rewrite program from an optical disk in which plural pieces of firmware corresponding to the hardware specifications of plural disk apparatuses and plural rewrite programs for rewriting the respective pieces of firmware have been recorded;
a transfer unit which transfers the firmware and the associated rewrite program read by the reading unit to a RAM; and
a writing unit which executes the rewrite program transferred to the RAM, writes the firmware transferred to the RAM in the flash ROM, and writes the rewrite program transferred to the RAM in the flash ROM.

3. The firmware rewrite system according to claim 2, wherein when a rewrite program has been written in the flash ROM, the transfer unit transfers the rewrite program written in the flash ROM to the RAM.

4. The firmware rewrite system according to claim 2, wherein when there is a free capacity in the flash ROM to write a rewrite program, the writing unit writes the rewrite program transferred to the RAM in the flash ROM.
